(19) United States
(12) Patent Application Publication
(10) Pub. No.: US 2009/0070427 A1
(43) Pub. Date: Mar. 12, 2009

(54) SYSTEM AND METHOD FOR DEVICE-DIRECTED PROCESSING OF REMOTE DESKTOP DOCUMENTS

(76) Inventors: Fabio M. GAVA, Ladera Ranch, CA (US); Hongfeng Wei, Anaheim, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/852,010

(22) Filed: Sep. 7, 2007

(51) Int. Cl. G06F 15/16

(52) U.S. Cl. 709/206

(57) ABSTRACT

The subject application is directed to a system and method for device-directed processing of remote desktop documents. A controller functionally integrated with a document processing device is first connected with remote workstations via a computer network. An electronic document is received from one of the workstations having an associated document identifier. Identification data is then received from an associated user via a user interface associated with the controller. A received electronic document is associated with the received identification data according to the associated identifier. A workstation is then identified based upon such association. Active document data is then received representing active electronic documents on each of the workstations. Indicia is generated on a display associated with the user interface corresponding to the received active document data. Selection data is received corresponding to a selected electronic document. A document processing operation is then commenced according to the received selection data.

### BACKGROUND OF THE INVENTION

The subject application is directed generally to document processing operations via shared, network peripherals. The application is particularly suited to efficient processing of documents received at a document processing device from a workstation wherein modification of previously submitted output characteristics is readily made.

Office operations will typically use networked workstations and shared peripherals for their document processing operations. Users will create or edit electronic documents in their offices or cubicles, operating on applications such as word processing, spreadsheets, databases, CAD, photo editing, electronic mail, facsimile, and the like. Rather than have the expense and support issues associated with document processing devices dedicated to individual users, most office operations will have shared devices that are in data communication with each workstation via a data network. Such document processing devices include printers, facsimile machines, plotters, copiers, or scanners. More recently, two or more functions are combined in a single document processing device, commonly referred to as a multifunction peripheral or “MFP.”

In a typical operation, a user has one or more active documents on a workstation. Such documents may be opened in connection with an associated application, such as a word processing document being opened for editing or creation. Once an output, such as a printout, is desired, a user commences the operation such as by calling a print driver, selecting print characteristics, selecting an output destination, and sending the electronic document for printing. A user then physically moves from the workstation to the shared device, and awaits output or retrieves a document that is already printed.

Unfortunately, many times a user may notice that an output document did not conform to their needs. By way of example, the user's job may have been queued as simplex or single-sided printing, when duplex or double sided printing was desired. As another example, a job may have been submitted to an inappropriate paper source, or another user may have substituted undesired stock in selected input tray. In any such instance, a user would typically address the situation, and return to their workstation to resend their document to address their concerns. This requires lost productivity and extra effort by users desiring to secure document output in required format.

### SUMMARY OF THE INVENTION

In accordance with one embodiment of the subject application, there is provided a system and method directed to document processing operations via shared, network peripherals.

Further, in accordance with one embodiment of the subject application, there is provided a system and method for efficient processing of documents received at a document processing device from a workstation wherein modification of previously submitted output characteristics is readily made.

Still further, in accordance with one embodiment of the subject application, there is provided a system for device-directed processing of remote desktop documents. The system comprises a document processing controller functionally integrated with an associated document processing device, a user interface operatively associated with the controller and disposed proximate thereto, the user interface including a data input and a display, and means adapted for connecting the document processing controller with each of a plurality of remote workstations via an associated network. The system also comprises means adapted for receiving at least one electronic document from at least one of the plurality of remote workstations via the associated network, wherein each received electronic document has a document identifier associated therewith and means adapted for receiving identification data from an associated user via the user interface. The system further comprises association means adapted for associating a received electronic document with received identification data in accordance with an identifier associated therewith and means adapted for identifying at least one workstation from the plurality thereof in accordance with an output of the association means. The system also includes active document isolation means adapted for receiving active document data representative of active electronic documents disposed on each identified workstation and means adapted for generating indicia on the display corresponding to received active document data. The system further includes means adapted for receiving selection data representative of at least one selected electronic document corresponding to generated indicia and means adapted for commencing at least one document processing operation via the document processing device in accordance with received selection data.

In one embodiment of the subject application, the active document isolation means includes means adapted for receiving active document data representative of an electronic document currently opened in connection with an application running on a workstation associated therewith.

In another embodiment of the subject application, the system also comprises means adapted for receiving job output data corresponding to each received electronic document from an associated workstation via the associated network, wherein job output data corresponds to selection of a tangible document output property for an associated output document by the document processing device. In such embodiment, the means adapted for receiving selection data is via the user interface and the received selection data includes job output data, wherein such received selected data alters the tangible document output property specified by received job output data.

In yet another embodiment of the subject application, the system also includes a web service application disposed on each associated workstation, wherein each web service application including means adapted for determining open electronic documents on its associated workstation and means adapted for communicating data with the active document isolation means. Preferably, the system also comprises means adapted for prompting a web service application of each associated workstation to commence retrieval of data corresponding to open electronic documents therefrom.

Still further, in accordance with one embodiment of the subject application, there is provided a method for device-directed processing of remote desktop documents in accordance with the system as set forth above.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for device-directed processing of remote desktop documents according to one embodiment of the subject application;

FIG. 2 is a block diagram illustrating device hardware for use in the system for device-directed processing of remote desktop documents according to one embodiment of the subject application;

FIG. 3 is a functional diagram illustrating the device for use in the system for device-directed processing of remote desktop documents according to one embodiment of the subject application;

FIG. 4 is a block diagram illustrating controller hardware for use in the system for device-directed processing of remote desktop documents according to one embodiment of the subject application;

FIG. 5 is a functional diagram illustrating the controller for use in the system for device-directed processing of remote desktop documents according to one embodiment of the subject application;

FIG. 6 is a flowchart illustrating a method for device-directed processing of remote desktop documents according to one embodiment of the subject application; and

FIG. 7 is a flowchart illustrating a method for device-directed processing of remote desktop documents according to one embodiment of the subject application.

### DETAILED DESCRIPTION OF THE PREFERRED EMBODIMENT

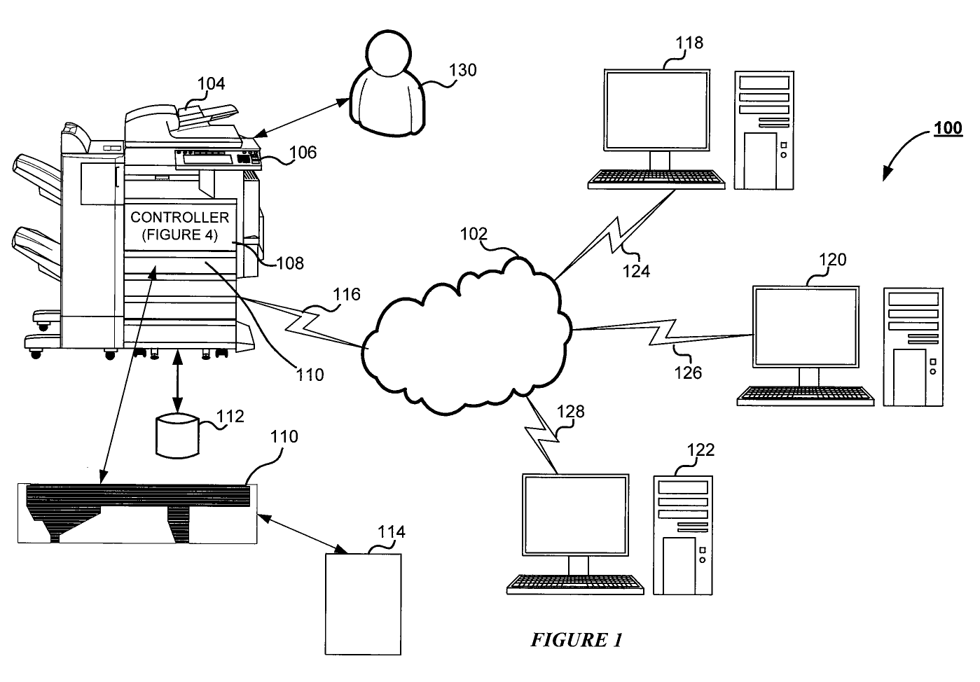

The subject application is directed to a system and method directed to document processing operations via shared, network peripherals. In particular, the subject application is directed to a system and method for efficient processing of documents received at a document processing device from a workstation wherein modification of previously submitted output characteristics is readily made. More particularly, the subject application is directed to a system and method that allows a user to remotely access electronic documents on a workstation from the user interface of an associated document processing device. It will become apparent to those skilled in the art that the system and method described herein are suitably adapted to a plurality of varying electronic fields employing remote access, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for device-directed processing of remote desktop documents in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

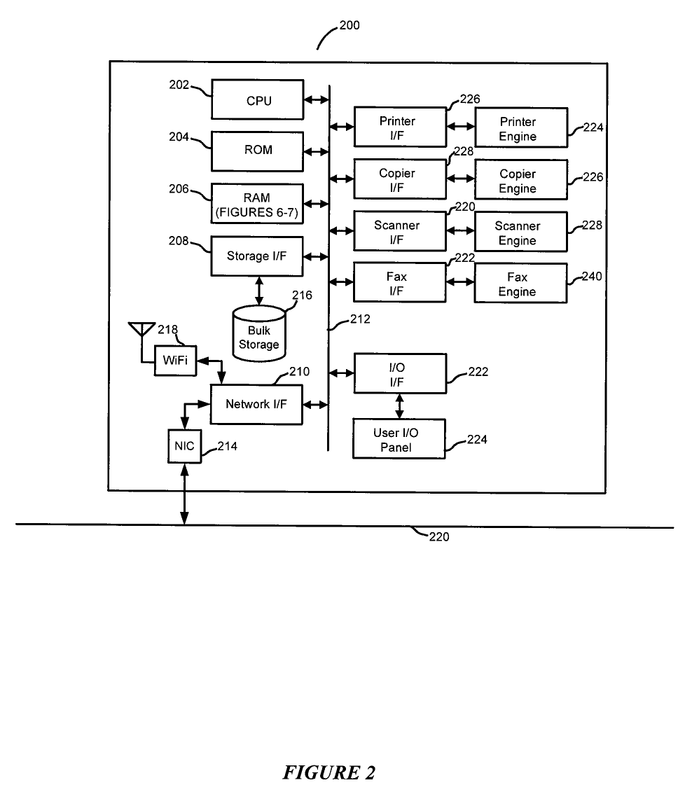

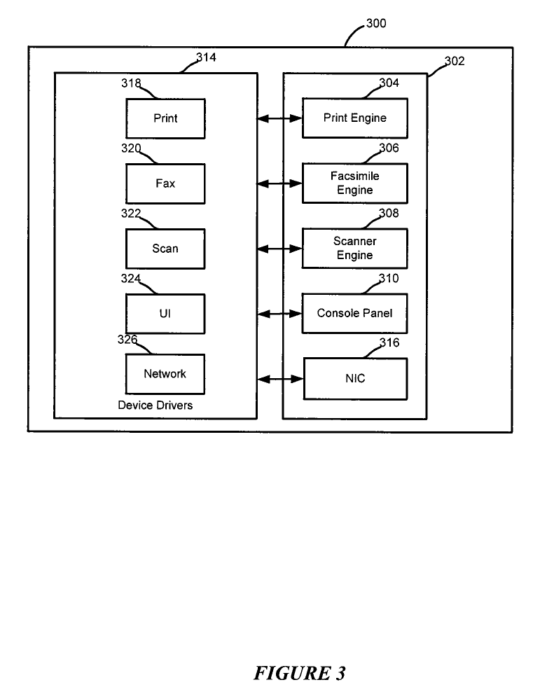

The system 100 also includes a document processing device 104, which is depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like. The functioning of the document processing device 104 will better be understood in conjunction with the block diagrams illustrated in FIGS. 2 and 3, explained in greater detail below.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a communications link 116. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

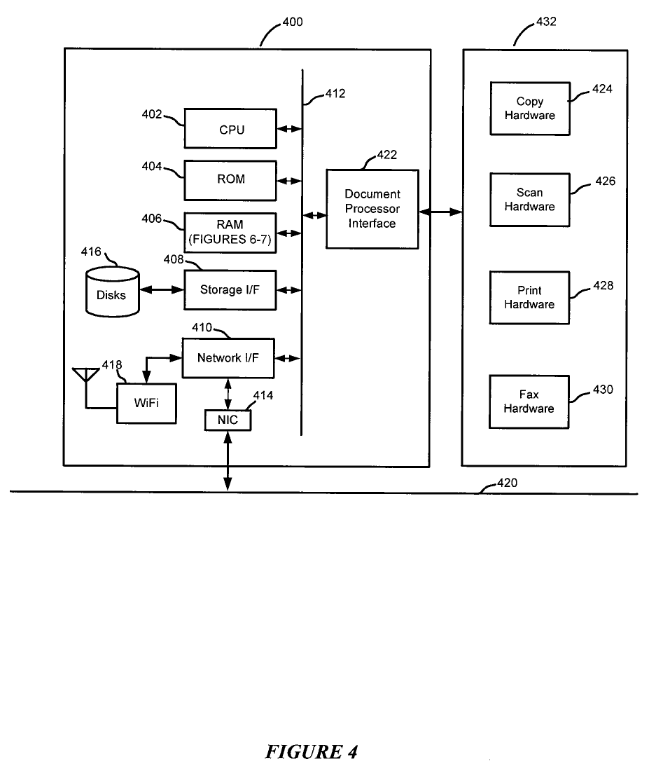

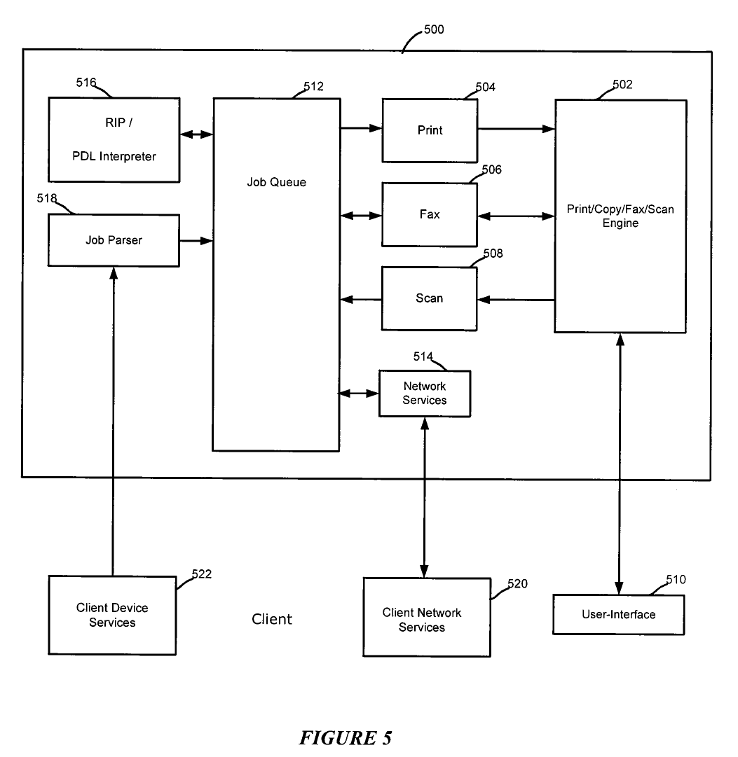

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 is capable of being performed by any general purpose computing system, known in the art, and thus the controller 108 is representative of such general computing devices and are intended as such when used hereinafter. Furthermore, the use of the controller 108 hereinafter is for the example embodiment only, and other embodiments, which will be apparent to one skilled in the art, are capable of employing the system and method for device-directed processing of remote desktop documents of the subject application. The functioning of the controller 108 will better be understood in conjunction with the block diagrams illustrated in FIGS. 4 and 5, explained in greater detail below.

As depicted in FIG. 1, the document processing device 104 further includes one or more media storage trays 110, suitably configured to stored output media 114 for output by the document processing device 110. The skilled artisan will appreciate that the media storage tray 110 is representative of any of a myriad of storage components associated with the document processing device 104 capable of storing sheets of paper of varying sizes, sheets of transparencies, blank greeting cards, blank business cards, photographic paper, envelopes, or any other output medium upon which documents or images are rendered.

Communicatively coupled to the document processing device 104 is a data storage device 112. In accordance with the preferred embodiment of the subject application, the data storage device 112 is any mass storage devices known in the art including, for example and without limitation, magnetic storage drives, a hard disk drive, optical storage devices, flash memory devices, or any suitable combination thereof. In the preferred embodiment, the data storage device 112 is suitably adapted to store document data, image data, electronic database data, or the like. It will be appreciated by those skilled in the art that while illustrated in FIG. 1 as being a separate component of the system 100, the data storage device 112 is capable of being implemented as an internal storage component of the associated document processing device 104, a component of the controller 108, or the like, such as, for example and without limitation, an internal hard disk drive, or the like. In accordance with one embodiment of the subject application, the data storage device 112 is capable of storing electronic documents, images, fonts, applications, and the like.

The system 100 illustrated in FIG. 1 further depicts a first user device 118, a second user device 120, and a third user device 122 in data communication with the computer network 102 via respective communications links 124, 126, and 128. It will be appreciated by those skilled in the art that the user devices 118-122 are shown in FIG. 1 as workstation computers for illustration purposes only. As will be understood by those skilled in the art, the user devices 118-122 are representative of any personal computing devices known in the art, including, for example and without limitation, a laptop computers, personal computers, personal data assistants, web-enabled cellular telephones, smart phones, proprietary network devices, or other web-enabled electronic devices. The communications links 124-128 are any suitable channels of data communication known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art.

In accordance with one embodiment of the subject application, the user devices 118-122 are suitably adapted to generate and transmit electronic documents, document processing instructions, user interface modifications, upgrades, updates, personalization data, or the like, to the document processing device 104, or any other similar device coupled to the computer network 102. In accordance with one embodiment of the subject application, the user devices 118-122 include an operating system, such as those manufactured by MICROSOFT CORPORATION, remote desktop access applications, web browser applications, and the like, which enable the secure interaction with the document processing device 104, or other network-connected devices. The skilled artisan will appreciate that the user devices 118-122 are also capable operating a myriad of various software applications, printer drivers, and the like, which are capable of communicating electronic documents to the document processing device 104 for output thereon.

Turning now to FIG. 2, illustrated is a representative architecture of a suitable device 200, shown in FIG. 1 as the document processing device 104, on which operations of the subject system are completed. Included is a processor 202, suitably comprised of a central processor unit. However, it will be appreciated that the processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the device 200.

Also included in the device 200 is random access memory 206, suitably formed of dynamic random access memory, static random access memory, or any other suitable, addressable memory system. Random access memory provides a storage area for data instructions associated with applications and data handling accomplished by the processor 202.

A storage interface 208 suitably provides a mechanism for volatile, bulk or long term storage of data associated with the device 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the device 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface card 214 is interconnected for data interchange via a physical network 220, suitably comprised of a local area network, wide area network, or a combination thereof.

Data communication between the processor 202, read only memory 204, random access memory 206, storage interface 208 and the network subsystem 210 is suitably accomplished via a bus data transfer mechanism, such as illustrated by bus 212.

Suitable executable instructions on the device 200 facilitate communication with a plurality of external devices, such as workstations, document processing devices, other servers, or the like. While, in operation, a typical device operates autonomously, it is to be appreciated that direct control by a local user is sometimes desirable, and is suitably accomplished via an optional input/output interface 222 to a user input/output panel 224 as will be appreciated by one of ordinary skill in the art.

Also in data communication with bus 212 are interfaces to one or more document processing engines. In the illustrated embodiment, printer interface 226, copier interface 228, scanner interface 230, and facsimile interface 232 facilitate communication with printer engine 234, copier engine 236, scanner engine 238, and facsimile engine 240, respectively. It is to be appreciated that the device 200 suitably accomplishes one or more document processing functions. Systems accomplishing more than one document processing operation are commonly referred to as multifunction peripherals or multifunction devices.

Turning now to FIG. 3, illustrated is a suitable document processing device (shown in FIG. 1 as the document processing device 104) for use in connection with the disclosed system. FIG. 3 illustrates suitable functionality of the hardware of FIG. 2 in connection with software and operating system functionality as will be appreciated by one of ordinary skill in the art. The document processing device 300 suitably includes an engine 302 which facilitates one or more document processing operations.

The document processing engine 302 suitably includes a print engine 304, facsimile engine 306, scanner engine 308 and console panel 310. The print engine 304 allows for output of physical documents representative of an electronic document communicated to the processing device 300. The facsimile engine 306 suitably communicates to or from external facsimile devices via a device, such as a fax modem.

The scanner engine 308 suitably functions to receive hard copy documents and in turn image data corresponding thereto. A suitable user interface, such as the console panel 310, suitably allows for input of instructions and display of information to an associated user. It will be appreciated that the scanner engine 308 is suitably used in connection with input of tangible documents into electronic form in bitmapped, vector, or page description language format, and is also suitably configured for optical character recognition. Tangible document scanning also suitably functions to facilitate facsimile output thereof.

In the illustration of FIG. 3, the document processing engine also comprises an interface 316 with a network via driver 326, suitably comprised of a network interface card. It will be appreciated that a network thoroughly accomplishes that interchange via any suitable physical and non-physical layer, such as wired, wireless, or optical data communication.

The document processing engine 302 is suitably in data communication with one or more device drivers 314, which device drivers allow for data interchange from the document processing engine 302 to one or more physical devices to accomplish the actual document processing operations. Such document processing operations include one or more of printing via driver 318, facsimile communication via driver 320, scanning via driver 322 and a user interface functions via driver 324. It will be appreciated that these various devices are integrated with one or more corresponding engines associated with the document processing engine 302. It is to be appreciated that any set or subset of document processing operations are contemplated herein. Document processors which include a plurality of available document processing options are referred to as multi-function peripherals.

Turning now to FIG. 4, illustrated is a representative architecture of a suitable backend component, i.e., the controller 400, shown in FIG. 1 as the controller 108, on which operations of the subject system 100 are completed. The skilled artisan will understand that the controller 400 is representative of any general computing device, known in the art, capable of facilitating the methodologies described herein. Included is a processor 402, suitably comprised of a central processor unit. However, it will be appreciated that processor 402 may advantageously be composed of multiple processors working in concert with one another as will be appreciated by one of ordinary skill in the art. Also included is a non-volatile or read only memory 404 which is advantageously used for static or fixed data or instructions, such as BIOS functions, system functions, system configuration data, and other routines or data used for operation of the controller 400.

Also included in the controller 400 is random access memory 406, suitably formed of dynamic random access memory, static random access memory, or any other suitable, addressable and writable memory system. Random access memory provides a storage area for data instructions associated with applications and data handling accomplished by processor 402.

A storage interface 408 suitably provides a mechanism for non-volatile, bulk or long term storage of data associated with the controller 400. The storage interface 408 suitably uses bulk storage, such as any suitable addressable or serial storage, such as a disk, optical, tape drive and the like as shown as 416, as well as any suitable storage medium as will be appreciated by one of ordinary skill in the art.

A network interface subsystem 410 suitably routes input and output from an associated network allowing the controller 400 to communicate to other devices. The network interface subsystem 410 suitably interfaces with one or more connections with external devices to the device 400. By way of example, illustrated is at least one network interface card 414 for data communication with fixed or wired networks, such as Ethernet, token ring, and the like, and a wireless interface 418, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 514 is interconnected for data interchange via a physical network 420, suitably comprised of a local area network, wide area network, or a combination thereof.

Data communication between the processor 402, read only memory 404, random access memory 406, storage interface 408 and the network interface subsystem 410 is suitably accomplished via a bus data transfer mechanism, such as illustrated by bus 412.

Also in data communication with bus the 412 is a document processor interface 422. The document processor interface 422 suitably provides connection with hardware 432 to perform one or more document processing operations. Such operations include copying accomplished via copy hardware 424, scanning accomplished via scan hardware 426, printing accomplished via print hardware 428, and facsimile communication accomplished via facsimile hardware 430. It is to be appreciated that the controller 400 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 400 of FIG. 4, (shown in FIG. 1 as the controller 108) as an intelligent subsystem associated with a document processing device. In the illustration of FIG. 5, controller function 500 in the preferred embodiment, includes a document processing engine 502. A suitable controller functionality is that incorporated into the Toshiba e-Studio system in the preferred embodiment. FIG. 5 illustrates suitable functionality of the hardware of FIG. 4 in connection with software and operating system functionality as will be appreciated by one of ordinary skill in the art.

In the preferred embodiment, the engine 502 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that are subset of the document processing operations listed above.

The engine 502 is suitably interfaced to a user interface panel 510, which panel allows for a user or administrator to access functionality controlled by the engine 502. Access is suitably enabled via an interface local to the controller, or remotely via a remote thin or thick client.

The engine 502 is in data communication with the print function 504, facsimile function 506, and scan function 508. These functions facilitate the actual operation of printing, facsimile transmission and reception, and document scanning for use in securing document images for copying or generating electronic versions.

A job queue 512 is suitably in data communication with the print function 504, facsimile function 506, and scan function 508. It will be appreciated that various image forms, such as bit map, page description language or vector format, and the like, are suitably relayed from the scan function 508 for subsequent handling via the job queue 512.

The job queue 512 is also in data communication with network services 514. In a preferred embodiment, job control, status data, or electronic document data is exchanged between the job queue 512 and the network services 514. Thus, suitable interface is provided for network based access to the controller function 500 via client side network services 520, which is any suitable thin or thick client. In the preferred embodiment, the web services access is suitably accomplished via a hypertext transfer protocol, file transfer protocol, uniform data diagram protocol, or any other suitable exchange mechanism. The network services 514 also advantageously supplies data interchange with client side services 520 for communication via FTP, electronic mail, TELNET, or the like. Thus, the controller function 500 facilitates output or receipt of electronic document and user information via various network access mechanisms.

The job queue 512 is also advantageously placed in data communication with an image processor 516. The image processor 516 is suitably a raster image process, page description language interpreter or any suitable mechanism for interchange of an electronic document to a format better suited for interchange with device functions such as print 504, facsimile 506 or scan 508.

Finally, the job queue 512 is in data communication with a parser 518, which parser suitably functions to receive print job language files from an external device, such as client device services 522. The client device services 522 suitably include printing, facsimile transmission, or other suitable input of an electronic document for which handling by the controller function 500 is advantageous. The Parser 518 functions to interpret a received electronic document file and relay it to the job queue 512 for handling in connection with the afore-described functionality and components.

In operation, a document processing controller functionally integrated with an associated document processing device is first connected with each of a plurality of remote workstations via an associated computer network. At least one electronic document is then received from one of the workstations via the network, with each received electronic document having an associated document identifier. Identification data is then received from an associated user via a user interface that is operative with and disposed proximate to the controller. A received electronic document is then associated with the received identification data according to the associated identifier.

A workstation is then identified based upon the association of the electronic document with the identification data and associated identifier. Active document data is then received representing active electronic documents on each of the identified workstations. Indicia is then generated on a display associated with the user interface of the document processing device corresponding to the received active document data. Selection data is then received corresponding to a selected electronic document corresponding to the generated indicia. A document processing operation is then commenced via the document processing device according to the received selection data.

According to one example embodiment of the subject application, each computer workstation 118, 120, and 122 are communicatively coupled to the controller 108 associated with the document processing device 104 via the computer network 102. One or more electronic documents are then received from a workstation 118, 120, or 122 by the controller 108 via the computer network 102. In accordance with one embodiment of the subject application, the electronic document includes an associated identifier corresponding to the received document. Job output data is then received by the controller 108 from the computer workstation 118, 120, or 122 corresponding to output properties associated with a tangible document output of the electronic document by the document processing device 104. It will be appreciated by those skilled in the art that the electronic document, identifier, and job output data are capable of being received from the workstation 118, 120, or 122 in the form of a document processing request submitted to the document processing device 104 via the computer network 102.

An associated user 130 then physically approaches the document processing device 104 so as to retrieve an output document, facilitate the completion of an operation, correct an error, load a desired output media, and the like. The associated user 130 then inputs identification data via the user interface 106 associated with the document processing device 104. It will be understood by those skilled in the art that the user interface 106 is operatively coupled to the controller 108, as set forth in FIGS. 2-5 above. In accordance with one embodiment of the subject application, the identification data corresponds, for example and without limitation, to a user ID, password, or other suitable identifying means known in the art. The received electronic documents are then associated with the corresponding identification data, as will be understood by those skilled in the art.

A workstation 118, 120, or 122 is then identified by the controller 108 in accordance with the association of the identification data with the electronic document. That is, the workstation 118, 120, or 122 from which the electronic document originated is identified by the controller 108. The controller 108 then determines the open documents on the identified workstation 118, 120, or 122 via a web services application operative on the workstation 118, 120, or 122. For example, when the originating workstation 118 is identified as the originator of an electronic document associated with an identified user 130, the controller 108 contacts the workstation 118 via the web services application, for those documents that are open, or active, on the workstation 118. It will be appreciated by those skilled in the art that active documents correspond to electronic files that are currently opened in a corresponding software application on the workstation 118, 120, or 122, e.g., word processing documents opened for editing in MICROSOFT WORD, spreadsheet documents opened for editing in MICROSOFT EXCEL, computer-aided design drawings open in AUTOCAD, or the like. Preferably, the web services application is operative on a MICROSOFT WINDOWS-based workstation 118, 120, or 122, as will be understood by those skilled in the art.

Active document data representing open electronic documents on the identified workstation 118, 120, or 122 is then received by the controller 108 from the identified workstation 118, 120, or 122 in connection with an application running on the workstation 118, 120, or 122. Such data is capable of including, for example and without limitation, document name, application name, document size, and the like. Indicia are then generated on the display of the user interface 106 corresponding to the active document data. Via the user interface 106, the user 130 is prompted to select an electronic document for modification, e.g., change output settings, select a new document nor originally sent to the document processing device 104, or the like. Following receipt of the user selection data, the controller 108 prompts the web service application to retrieve open document data corresponding to the selection made by the associated user 128.

The workstation 118, 120, or 122, via the web service application, then communicates the selected electronic document to the document processing device 104 via the computer network 102. The document processing device 104 thereafter commences a document processing operation on the selected electronic document. In accordance with one embodiment of the subject application, the user 130 is further capable of modifying the received job output data, e.g., changing paper size, finishing options, contrast, simplex/duplex, or the like, via interactions with the user interface 106. Other modifications to the selected electronic document are capable of being made by the user 130 via the user interface 106, as will be appreciated by those skilled in the art.

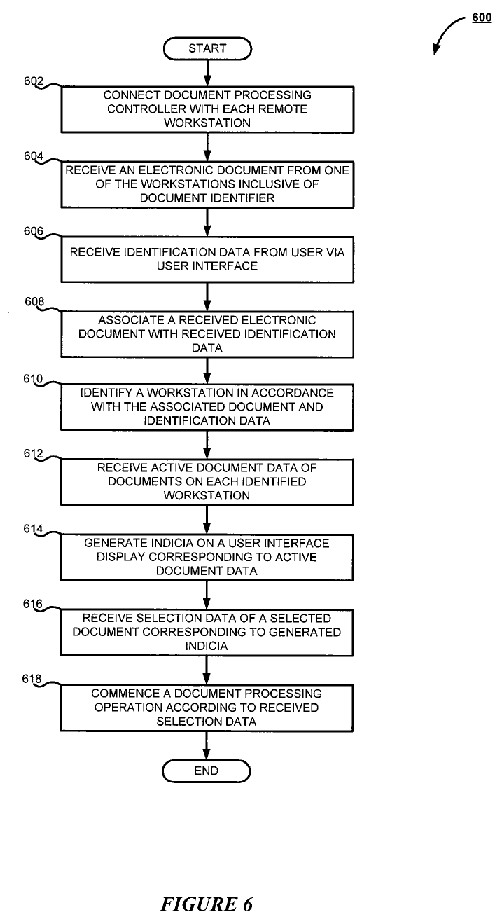

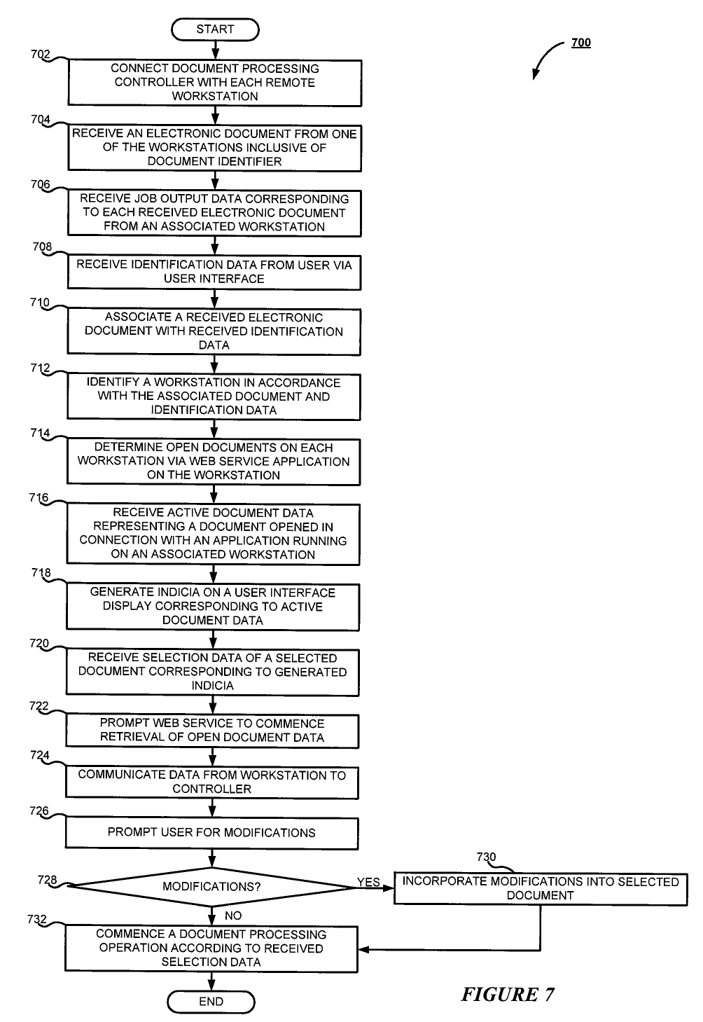

The skilled artisan will appreciate that the subject system 100 and components described above with respect to FIG. 1, FIG. 2, FIG. 3, FIG. 4, and FIG. 5 will be better understood in conjunction with the methodologies described hereinafter with respect to FIG. 6 and FIG. 7. Turning now to FIG. 6, there is shown a flowchart 600 illustrating a method for device-directed processing of remote desktop documents in accordance with one embodiment of the subject application. Beginning at step 602, a document processing controller 108, functionally integrated with an associated document processing device 104, is connected to each computer workstation 118, 120, and 122 via the computer network 102. At step 604, the controller 108 or other suitable component associated with the document processing device 104 receives one or more electronic documents from one of the workstations 118, 120, or 122 via the computer network 102. In accordance with one embodiment of the subject application, each received electronic document includes an associated document identifier.

At step 606, identification data is received from an associated user 130 via the user interface 106 associated with the document processing device 104. That is, the user 130 physically approaches the document processing device 104 so as to retrieve an output document, facilitate the completion of an operation, correct an error, and the like. It will be appreciated by those skilled in the art that the user interface 106 is communicatively coupled to the controller 108 via the document processing device 104. Preferably, the user interface 106 is located in close proximity to the document processing device 104, so as to facilitate the operation of the document processing device 104 by a walkup user 130. In accordance with one embodiment of the subject application, the identification data corresponds, for example and without limitation, to password data, username data, or other data identifying the user 130. At step 608, a received electronic document is associated with the received identification data according to the associated identifier.

A workstation 118, 120, or 122 is then identified at step 610 in accordance with the associated document and the identification data. That is, the controller 108 or other suitable component associated with the document processing device 104 identifies the workstation 118, 120, or 122 from which the electronic document originated based upon the identifier associated with the document and the user identification data received from the user 130. The controller 108 or other suitable component associated with the document processing device 104 then receives, at step 612, active document data from the identified workstation 118, 120, or 122. It will be appreciated by those skilled in the art that the controller 108 retrieves active document corresponding to each identified workstation 118, 120, and 122. The skilled artisan will appreciate that such active document data corresponds to electronic documents that are open for editing, modification, or the like, by associated software applications on the identified computer workstation 116, 118, 120.

At step 614, the controller 108 or other suitable component associated with the document processing device 104 then generates indicia on the display of the user interface 106 of the document processing device 104 corresponding to those active documents associated with the identified workstation 118, 120, or 122. The user 130 then selects, at step 616 an electronic document corresponding to a generated indicia on the user interface 106. Flow then proceeds to step 618, whereupon a document processing operation is commenced by the document processing device 104 in accordance with the selection data received from the user 130.

Referring now to FIG. 7, there is shown a flowchart 700 illustrating a method for device-directed processing of remote desktop documents in accordance with one embodiment of the subject application. The methodology of FIG. 7 begins at step 702, whereupon the controller 108, functionally integrated with the document processing device 104, is communicatively coupled to each computer workstation 118, 120, and 122 via the computer network 102. An electronic document, inclusive of an associated identifier, is then received at step 704 from one of the workstations 118, 120, or 122 by the controller 108 via the computer network 102.

At step 706, the controller 108 receives job output data from the computer workstation 118, 120, or 122 corresponding to selected output properties associated with a document processing operation to be performed by the document processing device 104 on the received electronic document. In accordance with one embodiment of the subject application, the electronic document, identifier, and job output data are received by the controller 108 from the workstation 118, 120, or 122 in the form of a document processing request submitted to the document processing device 104 via the computer network 102. An associated user 130 then physically approaches the document processing device 104 so as to retrieve a tangible output document, facilitate the completion of an operation, e.g., private print, correct an error, load a desired output media, and the like. Identification data is then received at step 708 from an associated user 130 via interaction with the user interface 106 associated with the document processing device 104. It will be appreciated by those skilled in the art that the identification data includes, for example and without limitation, to a user ID, password, or other suitable identifying means known in the art. At step 710, the received electronic document is then associated with the corresponding identification data, as will be understood by those skilled in the art. For example and without limitation, the electronic document identifier indicates that the user 130, corresponding to the received identification data, is associated with the received electronic document.

Flow then proceeds to step 712, whereupon one of the workstations 118, 120, or 122 is identified by the controller 108 based upon the association of the identification data with the electronic document, e.g., the originating workstation 118, 120, or 122. At step 714, the controller 108 communicates with a web service application operative on the identified workstation 118, 120, or 122 to determine which electronic documents are open thereon. For example, open documents correspond to those electronic documents open for editing by an associated software application on the identified workstation 118, 120, or 122. In accordance with one embodiment of the subject application, the web services application is operative on a MICROSOFT WINDOWS-based workstation 118, 120, or 122, as will be understood by those skilled in the art.

Active document data, i.e., representing open electronic documents, is then received by the controller 108 at step 716 from the identified workstation 118, 120, or 122 in connection with an application running on the workstation 118, 120, or 122. Such data is capable of including, for example and without limitation, document name, application name, document size, and the like. At step 718, the controller 108, via the display associated with the user interface 106, directs the generation of indicia corresponding to the active document data. That is, the user interface 106 displays indicia, such as text, graphics, images, pages, and the like, associated with the received active data. Selection data is then received at step 720 from the user 130 via the user interface 106 corresponding to an electronic document for further operations by the document processing device 104. The controller 108 then prompts, at step 722, the web service to commence retrieval of open document data corresponding to the active electronic document selected by the user 130.

The identified workstation 118, 120, or 122 then communicates, via the web service application operative thereon, the selected open document data to the document processing device 104 corresponding to the selected electronic document at step 724. The user 130 is then prompted, at step 726, for modification data corresponding to modifications to the selected document, the job output data, e.g., finishing options, paper selection, etc., and the like. A determination is then made by the controller 108 or other suitable component associated with the document processing device 104 whether the user 130 has input modifications at step 728. That is, whether the user 130, via the user interface 106, has input modifications to the selected electronic document, the received job output data, e.g., changing paper size, finishing options, contrast, simplex/duplex, or the like. When the user 130 has input modifications, flow proceeds to step 730, whereupon the modifications are incorporated into the selected electronic document. Thereafter, at step 732, the document processing device 104 commences a document processing operation on the selected electronic document in accordance with the job output data and any user modifications made thereto. Returning to step 728, when no modifications have been input by the user 130, flow proceeds directly to step 732, with the document processing device 104 commencing selected document processing operations on the selected electronic document.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for device-directed processing of remote desktop documents comprising:
a document processing controller functionally integrated with an associated document processing device;
a user interface operatively associated with the controller and disposed proximate thereto, the user interface including a data input and a display;
means adapted for connecting the document processing controller with each of a plurality of remote workstations via an associated network;
means adapted for receiving at least one electronic document from at least one of the plurality of remote workstations via the associated network, wherein each received electronic document has a document identifier associated therewith;
means adapted for receiving identification data from an associated user via the user interface;
association means adapted for associating a received electronic document with received identification data in accordance with an identifier associated therewith;
means adapted for identifying at least one workstation from the plurality thereof in accordance with an output of the association means;
active document isolation means adapted for receiving active document data representative of active electronic documents disposed on each identified workstation;
means adapted for generating indicia on the display corresponding to received active document data;
means adapted for receiving selection data representative of at least one selected electronic document corresponding to generated indicia; and
means adapted for commencing at least one document processing operation via the document processing device in accordance with received selection data.

2. The system of claim 1 wherein the active document isolation means includes means adapted for receiving active document data representative of an electronic document currently opened in connection with an application running on a workstation associated therewith.

3. The system of claim 1 further comprising:
means adapted for receiving job output data corresponding to each received electronic document from an associated workstation via the associated network, wherein job output data corresponds to selection of a tangible document output property for an associated output document by the document processing device; and wherein
the means adapted for receiving selection data is via the user interface, and which received selection data includes job output data, wherein such received selected data alters the tangible document output property specified by received job output data.

4. The system of claim 1 further comprising a web service application disposed on each associated workstation, each web service application including means adapted for determining open electronic documents on its associated workstation and means adapted for communicating data with the active document isolation means.

5. The system of claim 4 further comprising means adapted for prompting a web service application of each associated workstation to commence retrieval of data corresponding to open electronic documents therefrom.

6. A method for device-directed processing of remote desktop documents comprising the steps of:
connecting a document processing controller functionally integrated with an associated document processing device with each of a plurality of remote workstations via an associated network;
receiving at least one electronic document from at least one of the plurality of remote workstations via the associated network, wherein each received electronic document has a document identifier associated therewith;
receiving identification data from an associated user via a user interface operatively associated with the controller and disposed proximate thereto;
associating a received electronic document with received identification data in accordance with an identifier associated therewith;
identifying at least one workstation from the plurality thereof in accordance with an output of the associating step;
receiving active document data representative of active electronic documents disposed on each identified workstation;
generating indicia on a display associated with the user interface corresponding to received active document data;
receiving selection data representative of at least one selected electronic document corresponding to generated indicia; and
commencing at least one document processing operation via the document processing device in accordance with received selection data.

7. The method of claim 6 wherein the step of receiving active document data includes receiving active document data representative of an electronic document currently opened in connection with an application running on a workstation associated therewith.

8. The method of claim 6 further comprising the steps of:
receiving job output data corresponding to each received electronic document from an associated workstation via the associated network, wherein job output data corresponds to selection of a tangible document output property for an associated output document by the document processing device; and wherein
receiving selection data is via the user interface, and which received selection data includes job output data, wherein such received selected data alters the tangible document output property specified by received job output data.

9. The method of claim 6 further comprising the steps of determining open electronic documents on an each associated workstation via a web service application disposed on each associated workstation and communicating data with the document processing controller.

10. The method of claim 9 further comprising the step of prompting a web service application of each associated workstation to commence retrieval of data corresponding to open electronic documents therefrom.

11. A computer-implemented method for device-directed processing of remote desktop documents comprising the steps of:
connecting a document processing controller functionally integrated with an associated document processing device with each of a plurality of remote workstations via an associated network;
receiving at least one electronic document from at least one of the plurality of remote workstations via the associated network, wherein each received electronic document has a document identifier associated therewith;
receiving identification data from an associated user via a user interface operatively associated with the controller and disposed proximate thereto;
associating a received electronic document with received identification data in accordance with an identifier associated therewith;
identifying at least one workstation from the plurality thereof in accordance with an output of the associating step;
receiving active document data representative of active electronic documents disposed on each identified workstation;
generating indicia on a display associated with the user interface corresponding to received active document data;
receiving selection data representative of at least one selected electronic document corresponding to generated indicia; and
commencing at least one document processing operation via the document processing device in accordance with received selection data.

12. The computer-implemented method of claim 11 wherein the step of receiving active document data includes receiving active document data representative of an electronic document currently opened in connection with an application running on a workstation associated therewith.

13. The computer-implemented method of claim 11 further comprising the steps of:
receiving job output data corresponding to each received electronic document from an associated workstation via the associated network, wherein job output data corresponds to selection of a tangible document output property for an associated output document by the document processing device; and wherein
receiving selection data is via the user interface, and which received selection data includes job output data, wherein such received selected data alters the tangible document output property specified by received job output data.

14. The computer-implemented method of claim 11 further comprising the steps of determining open electronic documents on an each associated workstation via a web service application disposed on each associated workstation and communicating data with the document processing controller.

15. The computer-implemented method of claim 14 further comprising the step of prompting a web service application of each associated workstation to commence retrieval of data corresponding to open electronic documents therefrom.
